(19) United States
(12) Patent Application Publication
(10) Pub. No.: US 2011/0193434 A1
(43) Pub. Date: Aug. 11, 2011

(54) STARTING DEVICE

(76) Inventors: Stephan Kaske, Eberdingen (DE); Roman Pirsch, Koengen (DE); Walter Gerschwitz, Moensheim (DE); Gerlinde Gerschwitz, Moensheim (DE)

(21) Appl. No.: 12/935,234

(22) PCT Filed: Nov. 27, 2008
(86) PCT No.: PCT/EP2008/066341

§ 371 Date: Jan. 13, 2011

(30) Foreign Application Priority Data
Mar. 31, 2008 (DE) 10 2008 000883.4

(51) Int. Cl. H02K 7/116

(52) U.S. Cl. 310/83

(57) ABSTRACT

A starting device having a drive-end bracket, in which a bearing is fastened, having a drive shaft, the bearing in the bearing bracket at least indirectly supporting the drive shaft, having a starter pinion which is fastened on the drive shaft so that a torque is able to be transferred from the drive shaft to the starter pinion, the starter pinion having an end face and a retaining ring being situated on the drive shaft in a fixed manner, at the end face, the starter pinion having a recess in which a retaining element is situated, which prevents the retaining ring from spreading inadmissibly.

### FIELD OF THE INVENTION

The present invention relates to a starting device having a drive-end bracket.

### BACKGROUND INFORMATION

A starting device is discussed in German Document DE 10 2005 035 655 A1 which is executed as a so-called freely ejecting starter. “Freely ejecting” means that the pinion, which is provided to engage in the ring gear of an internal combustion engine, is only supported at one end, or rather only at one axial end of the pinion (overhung mounting). In the subject matter described there, a starter pinion is shown which is fastened to a drive shaft in such a way that, between the drive shaft and the starter pinion, a torque is able to be transmitted. In addition, the starter pinion is displaceable on the drive shaft, axially between two specified end positions.

Moreover, within the scope of this displaceability, the starter pinion is lightly spring mounted, so that when the starter pinion strikes against the ring gear, the entire mass inertia of the free wheel, of the drive shaft and of the pinion does not act on the ring gear, but, in a clearly diminished measure, only a part of it.

In the execution described here, the starter pinion appears, to one skilled in the art, to be secured using a retaining ring (spring ring), which is secured by a sleeve-type section, that encompasses the spring ring on its outer side, against expanding while exposed to centrifugal force, In this design approach, it is a disadvantage that it requires an unnecessarily long drive shaft. This leads to an unnecessarily large mass and, with that, to higher stop forces at the ring gear than is absolutely necessary.

### SUMMARY OF THE INVENTION

A starting device is provided, having a drive-end bracket in which a bearing is fastened, having a drive shaft, the bearing in the bearing bracket at least indirectly supporting the drive shaft, having a starter pinion which is fastened on the drive shaft in such a way that a torque is able to be transferred from the drive shaft to the starter pinion, the starter pinion having an end face and a retaining ring being situated on the drive shaft in a fixed manner. At the end face, the starter pinion has a recess in which a retaining element is situated which prevents the retaining ring from spreading inadmissibly.

Using the design approach provided, an attempt is made to prevent an inadmissible spreading of the retaining ring by providing a recess at the end face of the starter pinion, in which a retaining element is situated. The mass of the starter pinion and the drive shaft should be reduced in this context, and thereby also the mass inertia.

According to another embodiment of the present invention, it is provided that the retaining element be fastened in the recess with force-locking, the retaining element may be a ring, that is mounted in the recess using a press fit.

According to a further embodiment of the present invention, it is provided that the retaining element be mounted in the recess using continuous material, the retaining element may be formed as a ring which is held in the recess by an adhesive, by solder or, for instance, by a weld.

According to yet another embodiment of the present invention, it is provided that the retaining element be mounted in the recess with form-locking.

The preferences of the special embodiments are such that a particularly low material utilization be required to hold the retaining ring in place.

The exemplary embodiments and/or exemplary methods of the present invention will be elucidated in greater detail in the following text based on the figures.

### BRIEF DESCRIPTION OF THE DRAWINGS

FIG. 1 shows a starting device in a longitudinal section, the starting device being a so-called jaw starter, that is, the drive-end bracket encompasses the starter pinion like a jaw.

FIG. 2 shows in a cutout an end of the so-called freely ejecting starter, in a longitudinal section.

FIG. 3 shows a starter pinion in a cutout, having a retaining element which is mounted in the recess, using a press fit.

FIG. 4 shows a starter pinion in a cutout, having a retaining element which is mounted in the recess using the continuous material of a weld.

FIG. 5 shows a starter pinion in a cutout, having a retaining element which is mounted in the recess using an adhesion location.

FIG. 6 shows a cutout of a starter pinion and its recess, having a retaining element which is executed slightly conically, and therefore fits into an equally conical recess, and is there secured by form-locking against the conical outer wall of the recess.

### DETAILED DESCRIPTION

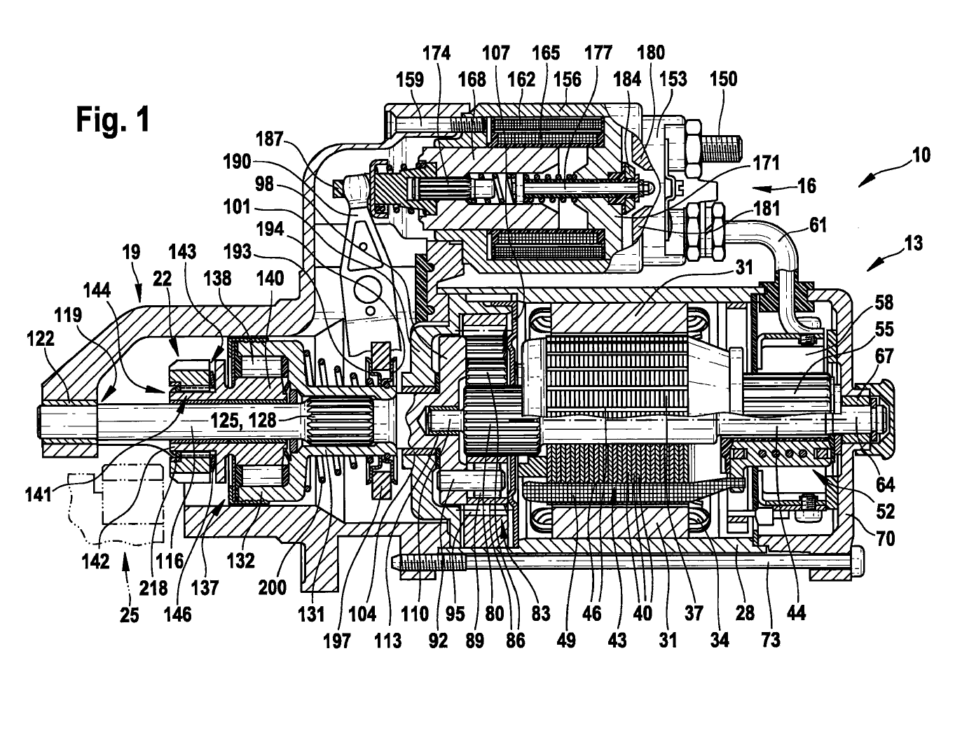

A starting device 10 is represented in FIG. 1. This starting device 10 has a starter motor 13 and an engaging relay 16, for example. Starter motor 13 and engaging relay 16 are fastened to a common drive-end bracket 19. Starter motor 13 is used functionally to drive a starting pinion 22 when it is engaged in ring gear 25 of the internal combustion engine that is not shown here.

Starter motor 13 has a pole tube 28 as housing, which carries pole shoes 31 on its inner diameter, which are each wound with a field winding 34. Pole shoes 31, in turn, surround an armature 37 which has an armature core 43 constructed of lamellae 40 and an armature winding 49 situated in slots 46. Armature core 43 is pressed onto a drive shaft 44. At the end of drive shaft 44 facing away from starting pinion 22, a commutator 52 is also mounted which, among other things, is constructed of individual commutator bars 55. Commutator bars 55, in a known way, are electrically connected to armature winding 49 in such a way that, when current is applied to commutator bars 55 by carbon brushes 58, a rotary motion of armature 37 in pole tube 28 comes about.

In closed-circuit condition, a power supply 61 between engaging relay 16 and starter motor 13 supplies both carbon brushes 58 and field winding 34 with current. Drive shaft 44 is supported on the commutator side using a shaft extension 64 in a journal bearing 67, which is in turn held in place in a commutator bearing cover 70. Commutator bearing cover 70, in turn, is fastened in drive-end bracket 19 using tension rods 73, which are situated distributed about the circumference of pole tube 28 (screws, 2, 3 or 4 of them). In this instance, pole tube 28 is supported on drive-end bracket 19, and commutator bearing cover 70 on pole tube 28.

A so-called sun wheel 80 adjoins armature 37 in the drive direction, and it is a part of a planetary gear 83. Sun wheel 80 is surrounded by several planet wheels 86, usually three planet wheels 86, which are supported on axle journals 92 using antifriction bearings 89. Planet wheels 86 ride on a ring gear 95, which is supported on the outside in pole tube 28. A planet carrier 98 adjoins planet wheels 86 in the direction towards the drive side, in which axle journals 92 are accommodated. Planet carrier 98, in turn, is supported in an intermediate bearing 101 and a journal bearing 104 situated in the latter. Intermediate bearing 101 is designed to be cup-shaped in such a way that both planet carrier 98 and planet wheels 86 are accommodated in it.

Furthermore, in cup-shaped intermediate bearing 101, ring gear 95 is situated which ultimately is closed off by a cover 107 from armature 37. Intermediate bearing 101 is also supported by its outer circumference on the inside of pole tube 28. At the end of drive shaft 44, facing away from commutator 52, armature 37 has an additional shaft extension 110 that is also accommodated in a journal bearing 113. Journal bearing 113, in turn, is accommodated in a central bore of planet carrier 98. Planet carrier 98 is connected as one piece to driven shaft 116. This drive shaft 116 is supported at its end 119 facing away from intermediate bearing 101 in an additional bearing 122, which is fastened in drive-end bracket 19. Bearing 122 supports drive shaft 44 indirectly via drive shaft 116, in this context.

Drive shaft 116 is subdivided into different sections: Thus the section that is situated in journal bearing 104 of intermediate bearing 101 is followed by a section having so-called straight-tooth bevels 125 (internal toothing), which is part of a so-called shaft-driving collar connection. This shaft-driving collar connection 128, in this case, enables the axially straight-line sliding of a follower 131. This follower 131 is a sleeve-like extension which is made in one piece with a cup-shaped outer ring 132 of free wheel 137. This free wheel 137 (unidirectional coupling) is further made up of inner ring 140, which is situated radially within outer ring 132. Between inner ring 140 and outer ring 132, sprags 138 are situated. These sprags 138, in cooperation with the inner ring and the outer ring, prevent the relative rotation between the outer ring and the inner ring in a second direction. In other words: Free wheel 137 enables a relative motion between inner ring 140 and outer ring 132 in only one direction. In this exemplary embodiment, inner ring 140, at its end facing away from free wheel 137, has a shaft-driving collar connection 141, such as splines or a groove toothing, which make possible the transfer of a torque from inner ring 140 to starter pinion 22.

For the sake of completeness, let us examine the engaging mechanism. Engaging relay 16 has a bolt 150 which is an electrical contact, and which is connected to the positive pole of an electric starter battery, which is not shown here. This bolt 150 is guided through a relay cover 153. This relay cover 153 closes off a relay housing 156, which is fastened to drive-end bracket 19, using several fastening elements 159 (screws). In engaging relay 16 there are also situated a pull-in winding 162 and a so-called hold-in winding 165. Pull-in winding 162 and hold-in winding 165 each act to form an electromagnetic field in the switched-on state, which flows through relay housing 156 (made of electromagnetically conductive material), through a linearly movable armature 168 and an armature magnetic yoke 171. Armature 168 carries a push rod 174 which, when armature 168 is linearly drawn in, is moved in the direction of a switching bolt 177. With this motion of push rod 174 to switching bolt 177, the latter is moved from its rest position in the direction towards two contacts 180 and 181, so that a contact bridge 184, mounted at the end of switching bolt 177 going towards the contacts 180 and 181, electrically connects the two contacts 180 and 181 to each other. Thereby electric power is conveyed from bolt 150, past contact bridge 184 to electric power supply 61 and therewith to carbon brushes 58. This causes current to flow through starter motor 13.

Engaging relay 16, or rather armature 168, in addition also has the task of moving a lever situated rotationally movable at drive-end bracket 19, using a pulling element 187. This lever 190, usually designed as a fork lever, encompasses two disks 193 and 194, using two “prongs” at their outer circumference, not shown here, in order to move an engaging piece 197, clamped between the latter, towards free wheel 137 against the resistance of spring 200, and thereby to engage starting pinion 22 with ring gear 25.

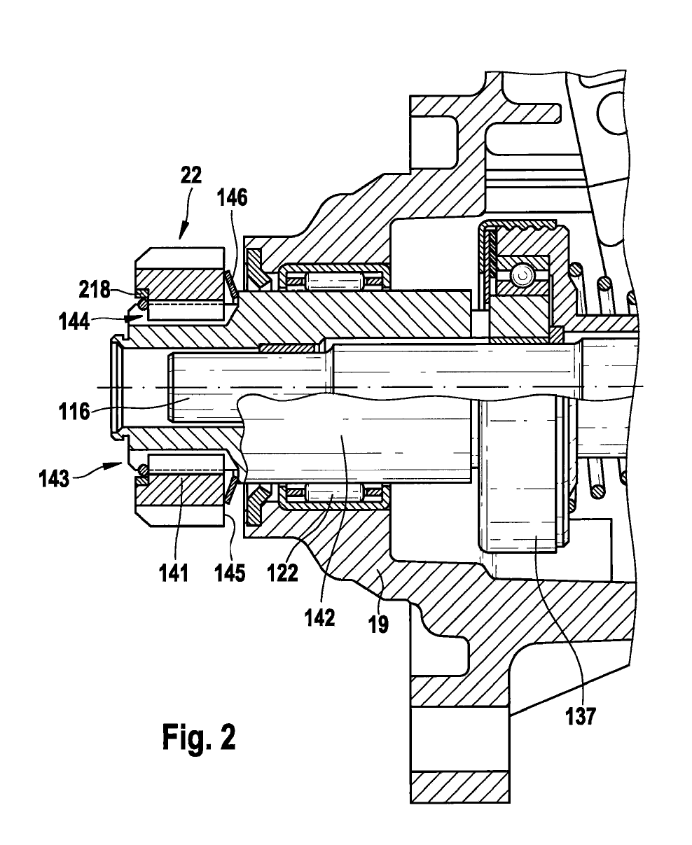

FIG. 2 shows a partial longitudinal section of a freely ejecting starter. It shows a bearing bracket 19 in which a bearing 122 is inserted which is developed, for example, as a roller bearing, if necessary, in a special form as a needle bearing. It may also be developed, however, as a journal bearing or a ball bearing.

In the two exemplary embodiments according to FIG. 1 and FIG. 2, starter pinion 22 sits on top of drive shaft 142. For this purpose, drive shaft 142 in both cases has a shaft-driving collar connection 141 on its outer circumference, which enables the transfer of a torque from inner ring 140 to starter pinion 22. Starter pinion 22 has a bore, which at its inner circumference has splines or a groove toothing, and which engages with a corresponding counterpart on drive shaft 142. The part of the shaft-driving collar connection on the drive shaft is designated as 143, and the part of the shaft-driving collar connection in the pinion is designated as 144. Starter pinion 22 is supported at one end face 145, that is directed towards free wheel 137, on a collar (not described in greater detail) of drive shaft 142, using a spring element 146, developed as a disk washer, in this case.

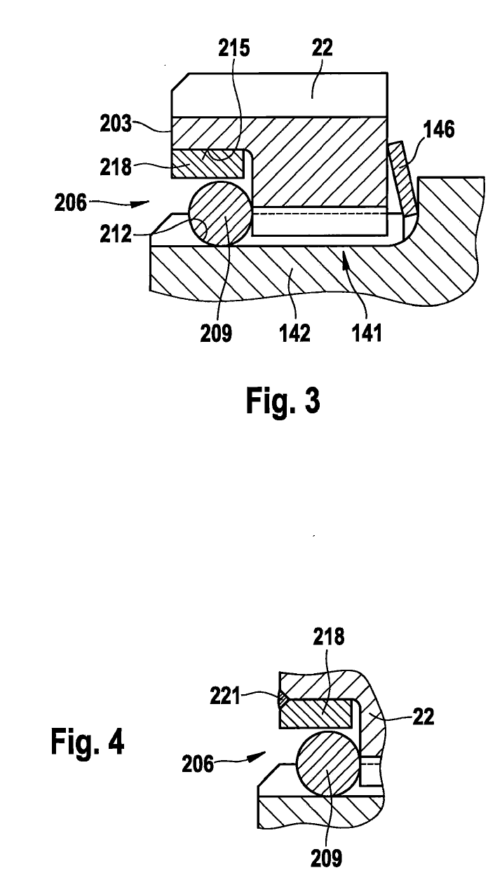

At an enlarged scale, FIG. 3 shows the connecting location between drive shaft 142 and starter pinion 22 for both design examples according to FIG. 1 and FIG. 2. Starter pinion 22 has an additional end face 203, situated on the other axial side of starter pinion 22, and accordingly faces away from free wheel 137. On this side of starter pinion 22, a recess 206 has been applied at the end face which, according to FIG. 3, is executed as a hollow cylinder. This recess 206 encompasses a retaining ring 209, which is executed as a spring ring, in this case. This retaining ring 209 is positioned in an encircling groove 212, which has been put into drive shaft 142 in the circumferential direction. A retaining element 218 has also been put into recess 206, which, in this case, is supported on the cylindrical side, or rather, jacket-like surface 215 of recess 206.

At this point, let us point out the assembly sequence: Onto shaft-driving collar connection 143, that is at first unequipped on the drive shaft side, spring element 146, that is, the spring disk, is first pushed on. Then starter pinion 22 is pushed onto drive shaft 142 so that recess 206 is facing away from free wheel 137. Subsequently, retaining ring 209, in a widened state, is pushed onto drive shaft 142, until retaining ring 209 snaps into groove 212. By blocking shaft-driving collar connection 143 on the drive shaft side, retaining ring 209 ensures the secure position of starter pinion 22 on drive shaft 142. In order that retaining ring 209 does not widen, while under centrifugal force stress (rotation at high angular velocity), in such a way that it is able to be pushed off drive shaft 142, while under axial load (spring disk 146), a retaining element 218 is positioned in recess 206. This retaining element 218 is dimensioned, in this instance, in such a way that a cylindrical surface, directed inwards, is situated so close to retaining ring 209 that the latter is not able to spread. In this context, retaining ring 209 may be dimensioned so that there is some play between the radial inner side of retaining element 218 and the outer side of retaining ring 209. This play should be there because on account of it, because of the back and forth movement of starter pinion 22, a force action on retaining element 218 in the axial direction is avoided. The reliable position is given thereby. In the exemplary embodiment according to FIG. 3, it is provided, in this instance, that retaining element 218 is mounted in recess 206 with force locking.

Accordingly, a starting device 10 is provided, having a drive-end bracket 19, in which a bearing 122 is fastened, having a drive shaft 142, the bearing 122 in bearing bracket 19 at least indirectly supporting drive shaft 142, having a starter pinion 22 which is fastened on drive shaft 142 in such a way that a torque is able to be transferred from the drive shaft 142 to the starter pinion 22, the starter pinion 22 having an end face 203 and a retaining ring 218 being situated on the drive shaft 142 in a fixed manner. It is provided, in this instance, that starter pinion 22 has a recess 206 at end face 203, in which retaining element 218 is positioned that prevents an inadmissible spreading of retaining ring 209.

Retaining ring 209 secures starter pinion 22 from slipping off drive shaft 142.

Retaining element 218 is mounted in recess 206 with force locking, that is, retaining element 218 is positioned on its cylindrical outer side in the cylindrical inner side of recess 206, and is retained in recess 206 using friction based on a pressure fit.

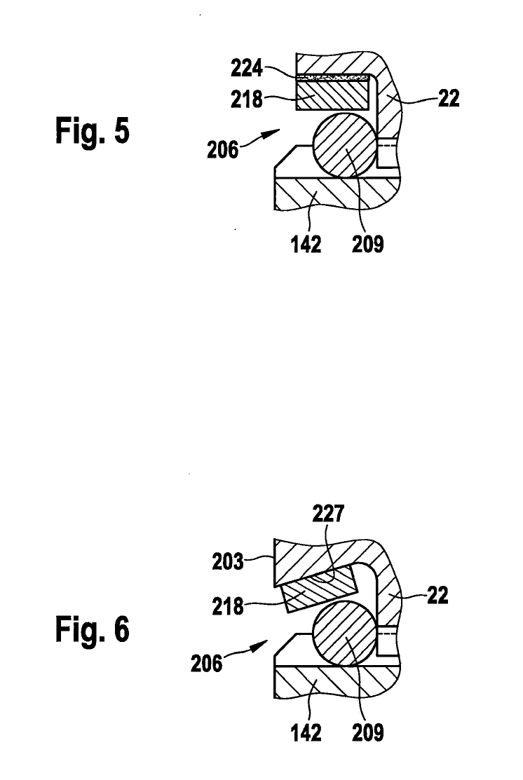

According to FIG. 4, it may alternatively be provided that retaining element 218 is held in recess 206 by continuous material. For this purpose, a continuous material connection in the form of a welding seam or a welding point, in any case, of a welding connection location 221, between starter pinion 22 and retaining element 218, is able to secure the position of retaining element 218. Alternatively, in case of suitable metal pairing, a soldering location may also be provided. According to FIG. 5, an adhesion location 224 may be provided, for example, which secures their position in recess 206 when located between starter pinion 22 and retaining element 218.

As a cutout, FIG. 6 shows recess 206 of starter pinion 22, recess 206 in this case showing no cylindrical outer contour, but a conical inner contour 227, which becomes wider starting from end fade 203 in the axial direction. This conical inner contour 227 supports a retaining ring 218, which has a slot on its circumference, and accordingly is not continuous and not closed. This retaining element 218 is a retaining element inserted into recess 206 under spring tension, which is inserted in slightly compressed fashion (that is the reason for the slot) into recess 206, and is unstressed after taking up its axially correct position. Because of this, the occasion arises that retaining element 218 is able to be supported on conical inner side 227 while being prestressed. This exemplary embodiment shows a retaining ring 218 secured with form locking.

1-9. (canceled)

10. A starting device, comprising:
a starter pinion;
a drive shaft; and
a drive-end bracket, in which a bearing is fastened, having the drive shaft, the bearing in the bearing bracket at least indirectly supporting the drive shaft, having the starter pinion which is fastened on the drive shaft so that a torque is transferrable from the drive shaft to the starter pinion, wherein the starter pinion has an end face and a retaining ring situated on the drive shaft in a fixed manner, and wherein the starter pinion has a recess at the end face, in which a retaining element is situated, which prevents the retaining ring from spreading inadmissibly.

11. The starter device of claim 10, wherein the retaining element is mounted in the recess with force locking.

12. The starter device of claim 11, wherein the retaining element is a ring, which is mounted in the recess using a pressure fit.

13. The starter device of claim 10, wherein the retaining element is mounted in the recess using a continuous material.

14. The starter device of claim 13, wherein the retaining element is a ring, which is mounted in the recess by one of an adhesion location and a weld.

15. The starter device of claim 10, wherein the retaining element is mounted in the recess using form locking.

16. The starter device of claim 10, wherein the retaining ring is a spring ring.

17. The starter device of claim 10, wherein the starter pinion is supported by a spring element, which is a disk spring, against the drive shaft in the axial direction, in a springy manner on the drive shaft.

18. The starter device of claim 10, wherein the bearing is an antifriction bearing, which is one of a roller bearing, a ball bearing, and a journal bearing.
